(19) United States
(12) Patent Application Publication
(10) Pub. No.: US 2013/0218796 A1
(43) Pub. Date: Aug. 22, 2013

(54) Securing User Information

(71) Applicant: Liang Feng, Hangzhou (CN)

(72) Inventor: Liang Feng, Hangzhou (CN)

(73) Assignee: ALIBABA GROUP HOLDING LIMITED, Grand Cayman (KY)

(21) Appl. No.: 13/383,251

(22) PCT Filed: Oct. 25, 2011
(86) PCT No.: PCT/US11/57733

§ 371 Date: Jan. 10, 2012

(30) Foreign Application Priority Data
Oct. 28, 2010 (CN) 201010524458.9

(51) Int. Cl. G06Q 50/26; G06Q 10/10

(52) U.S. Cl. CPC G06Q 50/265; G06Q 10/10
USPC 705/325

(57) ABSTRACT

The present disclosure provides for securing user information involved in e-commerce transactions without encrypting that information. The e-commerce platform system generates the order ID of the seller and the buyer and stores a relationship between the order ID and a buyer ID. The e-commerce platform system receives, from a logistics information system, information about where the buyer resides and an area code of that location. This can be accomplished over open communication between the e-commerce platform and the logistics information systems without using encryption. The e-commerce platform system then identifies a distribution center located in the area where the buyer resides. The user information is identifies through a connection between the e-commerce platform and the logistics information system. With this technique, the seller cannot obtain the user information of the buyer and the user information of the buyer cannot be leaked, thereby increasing security.

### CROSS REFERENCE TO RELATED PATENT APPLICATIONS

This application is a national stage application of an international patent application PCT/US11/57733, filed Oct. 25, 2011, which claims priority from Chinese Patent Application No. 201010524458.9 filed on Oct. 28, 2010, entitled “METHOD, SYSTEM AND E-COMMERCE PLATFORM FOR SECURING USER INFORMATION,” which applications are hereby incorporated by reference in their entirety.

### TECHNICAL FIELD

The present disclosure relates to a field of network communication and, more specifically, to a method, a system and an e-commerce system platform for securing user information.

### BACKGROUND

E-commerce is a new business operation model based on an open internet environment and browser/server application. Consumers can do online shopping, internet transactions, online e-payments, different commercial activities, transaction activities, financial activities, and related general services without in-person contacts between buyers and sellers. The implementation of e-commerce requires an e-commerce platform. When conducting transactions through the e-commerce platform, a buyer needs to provide a seller with user information such as the name, the telephone number, the delivery address, the zip code, and so forth. However, as the user information is usually private information (e.g., home address, work address, corresponding zip codes) it may be inappropriately used by a third-party if it is accessible to the public.

To secure the user information, the current techniques preset a reliable intermediary in the transaction process. The e-commerce platform sends the user information to the reliable intermediary after the transaction contract between the buyer and the seller is completed. The reliable intermediary encrypts the user information, generates an encrypted tag, and sends the encrypted tag to the seller. The seller delivers the product and the encrypted tag to a designated logistics company which is responsible for decrypting the encrypted tag, restoring the user information, and delivering the products to the buyer accordingly. When the encryption algorithm is a weak algorithm, the encrypted user information is vulnerable and can be easily decrypted by the third-party that obtains the encrypted tag. As there are multiple transportation segments inside the logistics company, the current techniques cannot solve the problem to secure the user information within the logistics company. In addition, as the encrypted tag is often a text comprising hundreds of characters, the seller and the logistics company are required to use special equipments to record the encrypted tag, which increases the complexities of the transactions process and the equipment costs.

### SUMMARY

The present disclosure provides for securing user information which is not well protected in the current techniques. There are many different ways to secure the user information.

In one embodiment, the present disclosure provides a method for securing user information. An e-commerce platform system generates an order identification (ID) between a seller and a buyer and stores a corresponding relationship between the order ID and a buyer ID. The e-commerce platform identifies a distribution center located in a district where the buyer resides according to the order ID and an area code provided by a logistics information system. The seller obtains the user information of the buyer according to buyer ID and the order ID from the e-commerce platform system and provides the user information of the buyer to the logistics information system.

In another embodiment, the present disclosure provides a system for securing user information, which includes the e-commerce platform system and the logistics information system. The e-commerce platform system generates the order ID between the seller and the buyer and stores the corresponding relationship between the order ID and the buyer ID. The logistics information system provides the order ID and the area code to the e-commerce platform system. The seller obtains the buyer ID and the order ID from the e-commerce platform system and provides them to the logistics information system.

The e-commerce platform identifies the distribution center located in the district where the buyer resides according to the order ID and the area code provided by the logistics information system. The e-commerce platform also obtains the user information of the buyer according to the buyer ID and the order ID sent by the logistics information system, and provides the user information of the buyer to the logistics information system.

In yet another embodiment, the present disclosure also provides the e-commerce platform having a generation unit, a storing unit, an identification unit, an obtaining unit, and a transmission unit. The generation unit generates the order ID between the seller and the buyer. The storing unit stores the corresponding relationship between the order ID and the buyer ID. The identification unit identifies the distribution center located in the district where the buyer resides according to the order ID and the area code provided by the logistics information system. The buyer ID and the order ID are obtained from the e-commerce platform system and provided to the logistics information system by the seller. The obtaining unit obtains the user information of the buyer according to the buyer ID and the order ID provided by the logistics information system. The transmission unit sends the user information of the buyer to the logistics information system.

According to the above exemplary embodiments, the e-commerce platform system generates the order ID of the seller and the buyer and stores a relationship between the order ID and a buyer ID. The e-commerce platform system identifies the distribution center located in the district where the buyer resides according to the order ID and the area code provided by the logistics information system, and obtains user information of the buyer according to the buyer ID and the order ID sent by the logistics information system. The e-commerce system then sends the user information of the buyer to the logistics information system. In the example embodiment, the present disclosure identifies the user information based on communication between the e-commerce platform and the logistics information systems. In such embodiments, the encryption algorithm is not used. The user information is identified through a connection between the e-commerce platform and the logistics information system. Thus the seller cannot obtain the user information of the buyer and the user information of the buyer cannot be leaked, thereby increasing security. When the user information is identified through the e-commerce platform, the user information can be obtained according to the order ID and the buyer ID. The identification speed is improved as few characters are compared in the identification process. In addition, as the seller provides limited information such as the order ID and the buyer ID, the error rate of information may be reduced and consequently the user's time can be saved.

### BRIEF DESCRIPTION OF THE DRAWINGS

To better illustrate embodiments of the present disclosure or techniques of the current technologies, the following is a brief introduction of figures to be used in descriptions of the embodiments. It is apparent that the following figures only relate to some embodiments of the present disclosure. A person of ordinary skill in the art can obtain other figures according to the figures in the present disclosure without creative efforts.

FIG. 1 illustrates a flow diagram of a first example embodiment of a method for securing user information.

FIG. 2 illustrates a flow diagram of a second example embodiment of a method for securing user information.

FIG. 3 illustrates a block diagram of an example embodiment of a system for securing user information. The system includes an e-commerce platform system and a logistics information system.

FIG. 4 illustrates a block diagram of a first example embodiment of an e-commerce platform system.

FIG. 5 illustrates a block diagram of a second example embodiment of an e-commerce platform system.

FIG. 6 illustrates a block diagram of an example identification module employed in the e-commerce platform systems of FIGS. 4 and 5.

### DETAILED DESCRIPTION

In various example embodiments below, some embodiments provide a method for securing user information and some embodiments provide a system and an e-commerce platform for securing user information. The present disclosure, by reference to the figures, describes the techniques as below.

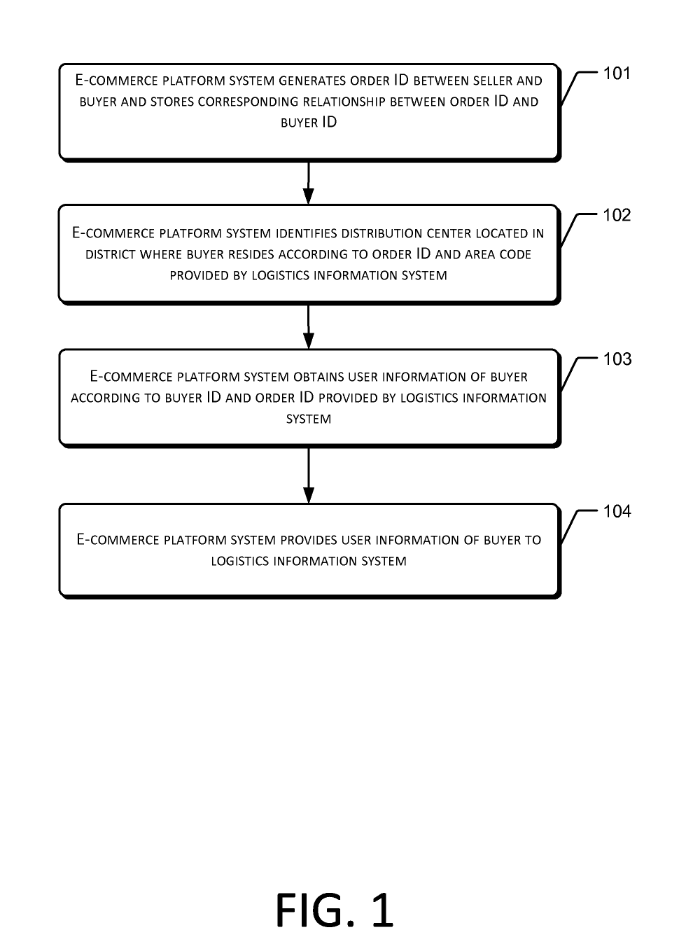

FIG. 1 illustrates a flow diagram of a first example embodiment of a method for securing user information in accordance with the present disclosure.

At 101, an e-commerce platform system generates an order identification (ID) between the seller and the buyer and stores the corresponding relationship between the order ID and the buyer ID. The e-commerce platform system is a network platform for both the buyer and the seller to complete the transaction. Both the buyer and the seller register with the e-commerce platform system. During a registration process of the buyer, the e-commerce platform records the user information of the buyer such as the user name, telephone number, addresses, zip code, and etc. The e-commerce platform system may assign a unique buyer ID to the buyer.

The buyer and the seller may communicate through communication tools such as an instant message tool in a manner of text, voice, and/or video to confirm the information of the product of transaction. If a mutual consent is reached, the buyer creates an order on the interface provided by the e-commerce platform system. The e-commerce platform system generates a corresponding transaction order according to the product information and assigns a unique order ID to the order.

The e-commerce platform system also stores the corresponding relationship between the order ID and the buyer ID. As the e-commerce platform system also preserves the user information of the buyer, which can be uniquely identified through the buyer ID, the user information of the buyer and the order ID can be correlated through the buyer ID. Thus, a relationship among the buyer ID, the order ID, and the user information of the buyer is created in the e-commerce platform system.

At 102, the e-commerce platform system identifies the distribution center located in the district where the buyer resides according to the order ID and the area code provided by the logistics information system. For example, the identification may include searching or inquiring the distribution center according to the order ID and the area code. In an example embodiment, the seller may only obtain the buyer ID and the order ID without other user information of the buyer from the e-commerce platform. As no other user information can be obtained, the user information of the buyer is kept secure. The present disclosure does not, however, limit that the buyer only obtains the buyer ID and order ID from the e-commerce platform. In other embodiments, in addition to the buyer ID and the order ID, the seller may also obtain some additional information of the buyer, such as the purchase record, the credit evaluation and etc., from the e-commerce platform system. The seller provides the buyer ID and the order ID to the logistics information system which is an information management system created by a logistics company for delivering products in different areas. In one example embodiment, all identifications of the user information are implemented through information exchanging between the logistics information system and the e-commerce platform system.

In one example embodiment, when the e-commerce platform system identifies the distribution center located in the district where the buyer resides, a hierarchy identification by level may be used. For example, the identification may start from a district distribution center where the seller locates and then continue level by level. As the seller and the buyer may live in different districts, the logistics company may deliver the product based on the internal logistics regional arrangement. During the delivery, the goods may be transported from the district distribution center of the district where the seller resides to the city distribution center of the city where the seller resides, then from the city distribution center of the city where the seller resides to the city distribution center of the city where the buyer resides; and then from the city distribution center of the city where the buyer resides to the district distribution center of the district where the buyer resides.

At any level of distribution center, the order ID and the area code of the district where the distribution center locates may be provided through the logistics information system to the e-commerce platform system by the customer terminal of the logistic information system at the distribution center. The e-commerce platform system identifies the address information from the user information of the corresponding buyer according to the order ID, and determines whether an area code corresponding to the address information is consistent with the area code of the distribution center. When a distribution center's area code matches the area code corresponding to the buyer, the e-commerce platform system determines that the distribution center is the one located in the district where the buyer resides.

At 103, the e-commerce platform system obtains the user information of the buyer according to the buyer ID and the order ID provided by the logistics information system. In one implementation, after determining that the distribution center located in the district where the buyer resides, the customer terminal of such distribution center may send the buyer ID and the order ID to the e-commerce platform system through the logistics information system. The e-commerce platform system identifies the pre-stored relationship according to the buyer ID and the order ID and obtains the user information of the buyer, such as the user name, the telephone number, the address, the zip code, etc. of the buyer.

At 104, the e-commerce platform system provides the user information of the buyer to the logistics information system. After the e-commerce platform sends the user information of the buyer to the logistics information system, the logistics information system may send the user information to the terminal equipment belong to the distribution center that is located in the district where the buyer resides by various communications such as a wireless communication. The courier holding the terminal equipment delivers the product to the buyer based on the received user information.

Alternatively, the logistics information system may send the user information of the buyer to the courier in different ways after receiving the user information of the buyer. For example, the logistics information system may send the user information of the buyer to the customer terminal of the distribution center located in the district where the buyer resides, and the courier obtains the information of the location where the buyer resides through the customer terminals and delivers the product to the buyer based on the information of the location where the buyer resides afterwards. In addition, the terminal equipment belonging to the distribution center that is located in the district where the buyer resides may connect to the logistic information system by wireless or wired communication, which is not limited by the present disclosure.

According to the above embodiment, the present disclosure may identify user information by communication between the e-commerce platform and the logistics information systems. The encryption to the user information may not be used in some embodiments. Through the by communication between the e-commerce platform and the logistics information systems, the seller cannot obtain the user information of the buyer and accordingly the user information of the buyer is secured. The user information can be obtained according to the order ID and the buyer ID while identifying the user information through the e-commerce platform. Thus the identification speed of identification the user information in the system can be improved as few characters need for the identification.

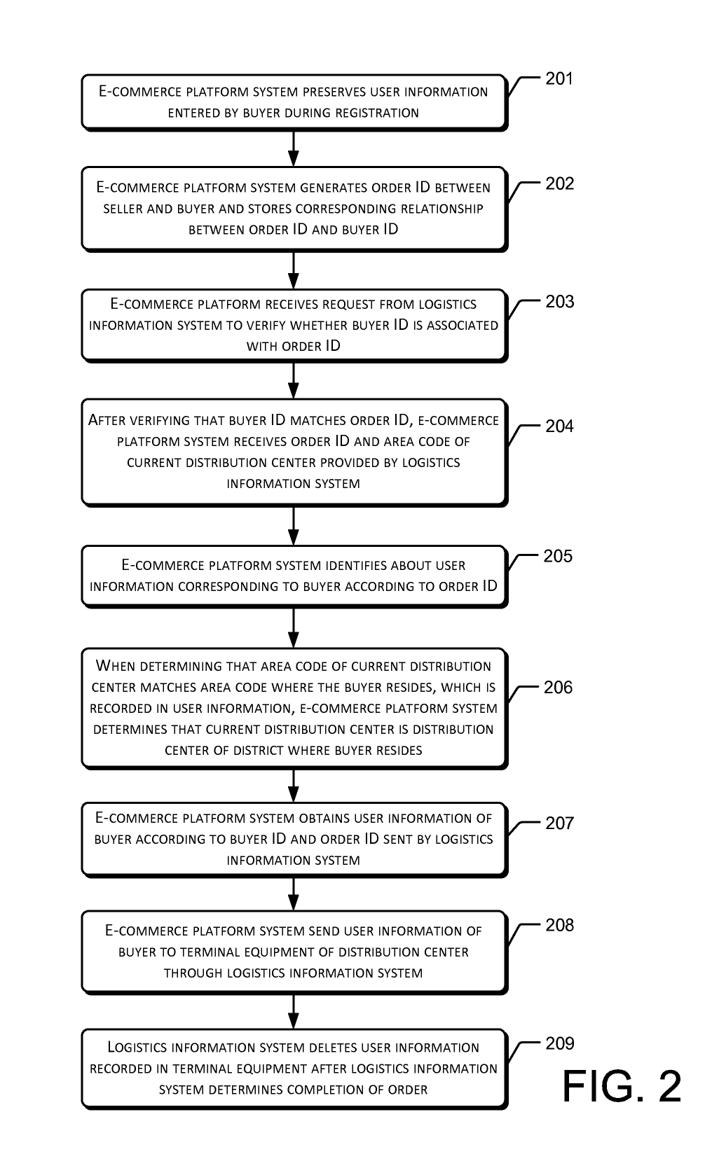

FIG. 2 illustrates a flowchart of a second example method of securing user information.

At 201, the e-commerce platform system preserves user information entered by the buyer during registration. As noted above, the e-commerce platform system is a network platform for both the buyer and the seller to complete the transaction. Both the buyer and the seller register with the e-commerce platform system. During a registration process of the buyer, the e-commerce platform records the user information of the buyer such as the user name, telephone number, addresses, zip code, and etc. The e-commerce platform system may assign a unique buyer ID to the buyer.

At 202, the e-commerce platform system generates the order ID between the seller and the buyer and stores the corresponding relationship between the order ID and the buyer ID. The buyer and the seller may communicate through communication tools such as the instant message tool in a manner of text, voice, and/or video to confirm the information of the product of transaction. If a mutual consent is reached, the buyer creates an order on the interface provided by the e-commerce platform system. The e-commerce platform system generates a corresponding transaction order according to the product information and assigns a unique order ID to the order. The e-commerce platform system also stores the corresponding relationship between the order ID and the buyer ID. As the e-commerce platform system also preserves the user information of the buyer, which can be uniquely identified through the buyer ID, the user information of the buyer and the order ID can be correlated through the buyer ID. Thus, a relationship among the buyer ID, the order ID, and the user information of the buyer is created in the e-commerce platform system.

At 203, the e-commerce platform receives a request from the logistics information system to verify whether the buyer ID matches the order ID. The seller can obtain the buyer ID and the order ID from the e-commerce platform system without other detailed user information of the buyer such as the specific address of the buyer. Therefore, the user information of the buyer can be secured. The seller provides the buyer ID and the order ID to the logistics information system. In the implementation, for example, the seller may write the user ID and the order ID on the delivery sheet, and deliver the sheet along with the product to the logistics company. As the seller only needs to write very few words instead of complex detailed mailing information, it's more convenient and efficient for the seller to input this information. The logistics information system is an information management system established by the logistics company for delivering products in different areas. In one embodiment, all identifications of the user information are implemented through interactive information exchanging between the logistics information system and the e-commerce platform system. In general, the logistics company assigns a courier to collect the product from the seller. The courier may input the buyer ID and the order ID provided by the seller to the terminal equipment. The terminal equipment, for example, may transmit the buyer ID and the order ID to the logistics information system through a network such as a wireless network.

After receiving the buyer ID and the order ID, the logistics information system can create connection with the e-commerce platform system and send the buyer ID and the order ID to the e-commerce platform system. The e-commerce platform system can then determine whether the buyer ID matches that associated with the order ID. Further, when the logistics information system communicates with multiple e-commerce platform systems, the seller may provide a corresponding e-commerce platform system ID number along with the buyer ID and the order ID so that the logistics information system can send the request of verification to the corresponding e-commerce platform system according to the e-commerce platform system ID number.

At 204, after verifying that the buyer ID is associated with the order ID, the e-commerce platform system receives the order ID and the area code of a current distribution center provided by the logistics information system.

As the seller and the buyer may live in different districts, the logistics company may deliver the product based on the internal logistics regional arrangement. During the delivery, the goods may be transported from the district distribution center of the district where the seller resides to the city distribution center of the city where the seller resides, then from the city distribution center of the city where the seller resides to the city distribution center of the city where the buyer resides; and then from the city distribution center of the city where the buyer resides to the district distribution center of the district where the buyer resides. At any level of distribution center, the order ID and the area code of the district where the distribution center locates may be provided through the logistics information system to the e-commerce platform system by the customer terminal of the logistic information system at the distribution center.

As the seller and the buyer may live in different cities, there is a transportation process for transporting the product. For example, the seller lives in BinJiang District, Hangzhou City, while the buyer lives in ChaoYang District, Beijing City. After the seller and the buyer complete a transaction of a book, the seller transports the book to the buyer through XX express shipping company. It might be difficult for the XX express shipping company to use its logistics information management system to directly assign this book to a courier in ChaoYang District because it usually takes two days to transport a book from Hangzhou City to Beijing City and the logistics information management system cannot predict whether a certain courier will be assigned for delivering this book two days later. Usually, the overall amounts of delivery, the distribution of the delivery addresses, and the number of the couriers of the ChaoYang branch of XX company on that day are taken into consideration for appropriate arrangement. Therefore, the transport process of that book is as follows: the district distribution center at BinJiang District, where the seller resides, collects the book and delivers the book to the city distribution center at Hangzhou City. Then, the city distribution center at Hangzhou City delivers the book to the city distribution center at Beijing City. Finally, the city distribution center at Beijing City delivers the book to the district distribution center at ChaoYang District, where the buyer resides.

At 205, the e-commerce platform system identifies the user information corresponding to the buyer according to the order ID.

At 206, when determining that the area code of the current distribution center matches the area code where the buyer resides, which is recorded in the user information, the e-commerce platform system determines that the current distribution center is the distribution center of the district where the buyer resides.

The e-commerce platform system identifies the address information from the user information of the corresponding buyer and determines whether the area code corresponding to the address information matches the area code of the distribution center. When an area code of any distribution center is found to match the area code of the district where the buyer resides, such distribution center can be determined as the distribution center located in the district where the buyer resides.

Still take the example that seller lives in BinJiang District, Hangzhou City, while the buyer lives in ChaoYang District, Beijing City. The book is firstly transported to the district distribution center at BinJiang District. The customer terminal at the district distribution center in BinJiang District provides the order ID and the area code of BinJiang District to the e-commerce platform system through the logistics information system. The e-commerce platform system identifies the user information of the buyer according to the order ID, and compares the area code of BinJiang District with the area code of ChaoYang District, where the buyer resides. Since the two area codes do not match, the e-commerce platform system returns an unmatched message to the logistics information system. Specifically, for example, the e-commerce platform system may provide certain message, such as “The delivery address is not within the current district. Please deliver the product to another distribution center of higher levels,” without sending the user information of the buyer to the logistics information system. Accordingly, the district distribution center at BinJiang District delivers the book to the city distribution center at Hangzhou City, and the customer terminal of the city distribution center at Hangzhou City provides the order ID and the area code of the Hangzhou City to the e-commerce platform system through the logistics information system. The e-commerce platform compares the area code of Hangzhou City with the area code of Beijing City, where the buyer resides. Since the two area codes do not match, the e-commerce platform system returns the unmatched message to the logistics information system. Because the buyer and the seller do not live in the same city, the e-commerce platform system returns the information of the city where the buyer resides, i.e., Beijing City, to the logistics information system (the e-commerce platform systems may return the information of the city of the buyer without disclosing the detailed address information of the buyer).

The city distribution center in Hangzhou City delivers the book to the city distribution center in Beijing City, and the customer terminal of the city distribution center in Beijing City provides the order ID and the area code of Beijing City to the e-commerce platform system through the logistics information system. The e-commerce platform compares the area code of Beijing City with the area code of Beijing City, where the buyer resides. If the two area codes match, the e-commerce platform system returns a “matched” message to the logistics information system, and returns the information of ChaoYang District, where the buyer resides, to the logistics information system (the e-commerce platform systems returns the information of the “district” where the buyer resides without disclosing the detailed address information of the buyer). The city distribution center in Beijing City delivers the book to the district distribution center in ChaoYang District, and the customer terminal of the district distribution center in ChaoYang District provides the order ID and the area code of ChaoYang District to the e-commerce platform system through the logistics information system. The e-commerce platform compares the area code of ChaoYang District with the area code of ChaoYang District, where the buyer resides. Since the two area codes match, the e-commerce platform system returns a “matched” message to the logistics information system, and obtains the user information of the buyer, such as the detailed address information, zip code information, the name of the user and the telephone number, and returns them to the customer terminal of the district distribution center in ChaoYang District.

As described in the above embodiment, during the product transport process, except for the district distribution center located in the district where the buyer resides, none of any other city distribution centers and district distribution centers needs to obtain the user information of the buyer. Therefore, the user information of the buyer is secured.

In one implementation, it is not necessary to limit the disclosure of the detailed address information of the buyer during the transport process as illustrated above. In some embodiments, only one or some distribution centers are designed not to be capable of obtaining the detailed address information of the user according to the real situations.

For example, when a courier who is assigned by the district distribution center where the seller resides to collect the product from the seller, the techniques may put limits on the courier to obtain the detailed address information of the buyer through the portable terminal equipment. The district distribution center where the courier works or other distribution centers may still be capable to obtain the address information of the buyer. In this way, the problem that the courier leaks the address information of the buyer can be prevented. The modified implementation described above can increase the flexibility of the present disclosure. As the risks that one or more distribution centers or the courier collecting the product from the seller may leak the detailed address information are reduced, the user information of the buyer can be further secured.

At 207, the e-commerce platform system obtains user information of the buyer according to the buyer ID and the order ID sent by the logistics information system.

After determining the distribution center located in the district where the buyer resides, the distribution center may send the buyer ID and the order ID to the e-commerce platform system through the logistics information system. The e-commerce platform system identifies the pre-established corresponding relationship according to the buyer ID and the order ID and obtains the user information of the buyer, such as the user name, the telephone number, the address, the zip code, etc. of the buyer.

At 208, the e-commerce platform system sends the user information of the buyer to the terminal equipment of the distribution center through the logistics information system.

The e-commerce platform system sends the user information of the buyer to the logistics information center, and the logistics information system sends the user information to the terminal equipment equipped by the distribution center located in the district where the buyer resides through a communication network such as wireless communication. The courier holding the terminal equipment delivers the product to the buyer according to on the user information.

At 209, the logistics information system deletes the user information recorded in the terminal equipment after the logistics information system determines the completion of the order. The terminal equipment of the logistics company can connect to the logistics information system through a communication network such as a wireless network. When the courier delivers the product to the buyer according to the user information, a message of completion of delivery is sent to the logistics information system through the terminal equipment. The logistics information system then sends an instruction to delete the user information record of the buyer in the terminal equipment and sends a “delivered” notice to the e-commerce platform system.

According to the above embodiment, the present disclosure can identify user information by communicating between the e-commerce platform and the logistics information systems. The seller cannot obtain the user information of the buyer and accordingly the user information of the buyer is secured. The user information can be obtained according to the order ID and the buyer ID while the user information is identified through the e-commerce platform. The identification speed can be improved as fewer characters need to be compared. As the risk of obtaining and leaking the user information of the buyer during the product transport process is reduced, and the user information of the buyer can be deleted once the delivery is completed, the illegal access to the user information from a third party can be prevented and the privacy of the buyer can be protected. In addition, as the seller only needs to provide limited information such as the order ID and the buyer ID, the error rate of information can be reduced and consequently the user's time can be saved.

An example of the transaction between the buyer and the seller is described below. It shows the detailed process of securing the user information.

At step 1, the buyer registers the user information on the e-commerce platform. The user information of the buyer may include the information such as the user name, telephone number, address, zip code of the buyer, and so on. The seller is not authorized to obtain the aforementioned user information from the e-commerce platform. The e-commerce platform assigns a unique buyer ID for the buyer, and stores the corresponding relationship between the user ID and the user information of the buyer such as the user name, telephone number, address, zip code, etc.

At step 2, the seller presents products in the internet shop at the e-commerce platform and sets the prices of products, the information of product (such as a location of the product, quantity of the product, and etc.), and the information of the logistics company which can be used for delivery and is located in the district where the seller resides. The e-commerce platform records the aforementioned information set by the seller. The e-commerce platform preserves the shipping fee charts of each logistics company and synchronizes with the fee data of the logistics companies in real-time.

At step 3, the buyer and the seller make transactions through the e-commerce platform. The buyer clicks the products listed online by the seller and selects the corresponding logistics company. The e-commerce platform can calculate the shipping fee automatically according to the fee charts and add it to the purchase cost of the buyer.

At step 4, the e-commerce platform generates the order and the order ID according to the purchase contract between the buyer and the seller. The buyer can pay through an electronic payment system and the e-commerce platform preserves the corresponding relationship between the buyer ID and the order ID.

At step 5, the e-commerce platform sends the buyer ID, the corresponding order ID, and the e-commerce platform ID number to the seller.

At step 6, the seller sends the buyer ID, the order ID, and the e-commerce platform ID number to the courier of the logistics company located in the district where the seller resides, and the courier inputs the above information into the terminal equipment. The terminal equipment connects to the logistics information system of the logistics company through a wireless network.

At step 7, the buyer ID, the order ID, and the e-commerce platform number are submitted to the logistics information management system through the terminal equipment. The product shipment number of the product may also be scanned by the terminal equipment.

At step 8, the logistics information management system requests the corresponding e-commerce platform to verify whether the user ID matches the order ID according to the e-commerce platform ID number.

At step 9, the e-commerce platform returns a matching result to the logistics information management system. If the user ID does not match the order ID, the e-commerce platform returns a reminder message to request the seller to check if the input information is incorrect.

At step 10, the logistics information system records the e-commerce platform ID number, the buyer ID, the order ID and the product shipment number after receiving the information indicating that the buyer ID matches the order ID.

At step 11, the logistics information system identifies the distribution center located in the district where the buyer resides level by level according to the buyer ID, the order ID, and the numbers of the districts where different distribution centers locate.

For example, the courier sends the product to the district distribution center of the logistics company located in the district where the seller resides. The manager of the district distribution center submits the order ID and the area code of the district to the logistics information system, and checks with the e-commerce platform whether the buyer of the product resides in this district through the logistics information system. The e-commerce platform can identify the user information of the buyer according to the preserved buyer ID and the order ID and determine whether the area code of this district matches the area code of the district where the buyer resides. If they match, the product is assigned to a courier of this district and the user information of the buyer, such as the user name, telephone numbers, addresses, zip codes of the buyer, etc. is obtained from the e-commerce platform through the logistics information system and the user information is sent to the courier's terminal equipment.

If they do not match, the district distribution center delivers the product to the city distribution center located in the city where the seller resides, and the manager of the city distribution center submits the order ID and the area code of the city to the logistics information system, and checks with the e-commerce platform whether the buyer of the product resides in this city through the logistics information system. The e-commerce platform can identify the user information of the buyer according to the preserved buyer ID and the order ID and determine whether the area code of this city matches the area code of the city where the buyer resides. If they match, the district information is obtained from the e-commerce platform and the product is sent to the corresponding district distribution center. The product is assigned to a courier of that district and the user information of the buyer, such as the user name, telephone numbers, addresses, zip codes of the buyer, and etc., is obtained from the e-commerce platform through the logistics information system and the user information is sent to the courier's terminal equipment.

If they do not match, the city information of the buyer is obtained from the e-commerce platform and the product is sent from the current city distribution center to a different city distribution center where the buyer resides. The manager of the city distribution center where the buyer resides submits the order ID and the area code of the district to the logistics information system, and checks with the e-commerce platform of the district information of the buyer and sends the product to the corresponding district distribution center. The manager of the distribution center submits the order ID and the area code of the district to the logistics information system. The e-commerce platform returns the message indicating that the area code of this district matches the area code of the district where the buyer resides. The user information of the buyer, such as the user name, telephone number, address, zip code of the buyer, and etc., is obtained from the e-commerce platform through the logistics information system and the user information is sent to the courier's terminal equipment. The courier delivers the product to the buyer according to the user information recorded in the terminal equipment.

At step 12: After the courier notes that the buyer signs off on the product through the terminal equipment, the corresponding sign-off record is uploaded to the logistics information system through the terminal equipment, and the transaction record of the buyer is deleted from the terminal equipment by the logistics information system automatically. In other words, the terminal equipment does not preserve the user information.

At step 13, the logistics information system returns the information indicating that the buyer accepts, such as signs off, the product to the e-commerce platform. After completing the acceptance, the logistics information system does not inquire information related to the product from the e-commerce platform, and does not accept any inquiry related to the product from different logistics distribution centers, in order to guarantee that the user information is secured from illegal access.

The logistics information system preserves all tracking record of the transaction, such as the e-commerce platform number, the buyer ID, the order ID, the product shipment number, the consignor, the contact number of the consignor, the time of receiving the product, the transport time, the transport address (the relevant district and city distribution centers), the acceptance time, and etc.

Corresponding to the method of securing user information of the present disclosure, the present disclosure also provides embodiments of a system and an e-commerce platform system securing user information.

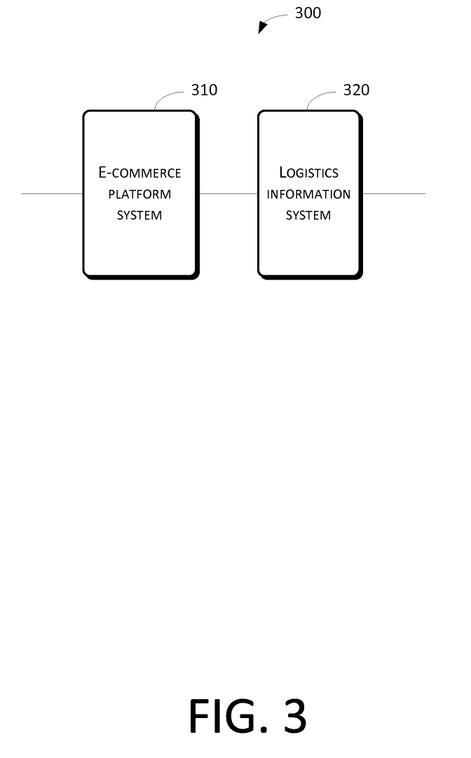

FIG. 3 illustrates a block diagram of an example system 300 of securing user information. The system 300 comprises the e-commerce platform system 310 and the logistics information system 320. The e-commerce platform system 310 generates the order ID between the seller and the buyer and preserves a corresponding relationship between the order ID and the buyer ID. The logistics information system 320 provides the order ID and the area code to the e-commerce platform system 310. The buyer ID and the order ID are obtained from the e-commerce platform system 310 and provided to the logistics information system 320 by the seller.

The e-commerce platform system 310 further identifies the distribution center located in the district where the buyer resides according to the order ID and the area code provided by the logistics information system 320, and obtains user information of the buyer according to the buyer ID and the order ID sent by the logistics information system 320, and sends the user information of the buyer to the logistics information system 320.

Further, the e-commerce platform system 310 may preserves the user information input by the buyer during registration. The user information may include, singly or in combination, the buyer ID, the buyer name, the telephone number, the address, and the zip code.

Further, after preserving a relationship between the order ID and a buyer ID, the e-commerce platform system 310 receives a request, from the logistics information system 320, to verify whether the buyer ID matches the order ID. The e-commerce platform 310 also identifies the district where the distribution center and the buyer reside according to the order ID and the area code provided by the logistics information system 320 after verifying that the buyer ID matches the order ID.

Further, the logistics information system 320 sends the user information of the buyer to the terminal equipment of the distribution center in the district where the buyer resides. Further, the logistics information system 320 deletes the user information recorded in the terminal equipment after determining the completion of the order.

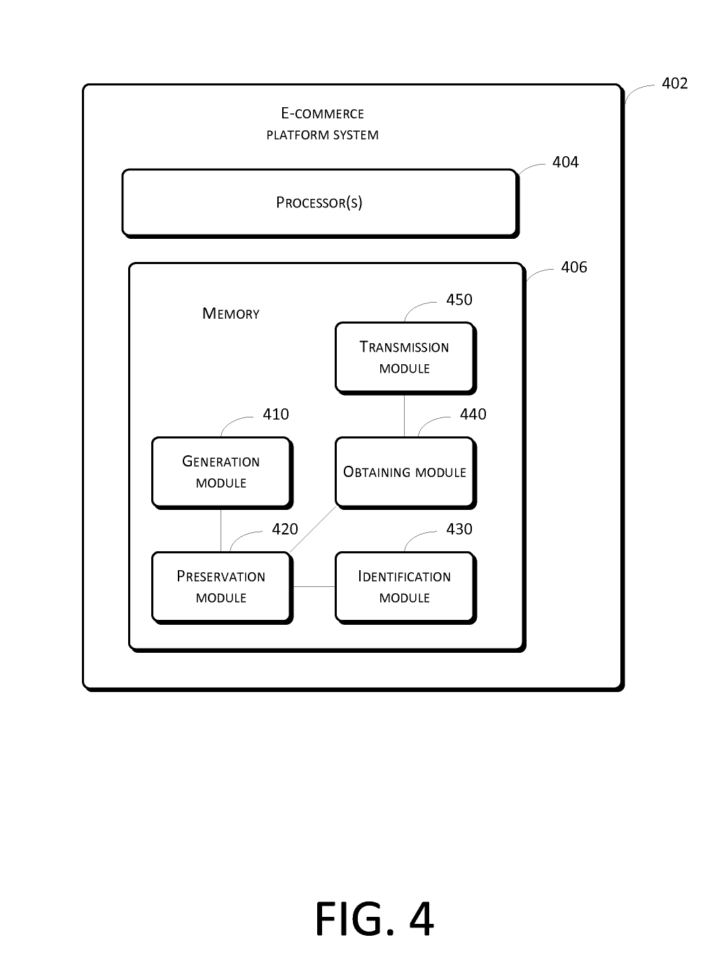

FIG. 4 illustrates a block diagram of an e-commerce platform system 402, which represents a first example implementation of the e-commerce platform system 310 of FIG. 3. In the illustrated embodiment, the e-commerce platform 402 may include, but is not limited to, one or more processors 404 and memory 406. The memory 406 may store therein one or more modules and/or program data. In one embodiment, the program modules may include a generation module 410, a preservation module 420, an identification module 430, an obtaining module 440, and a transmission module 450. The modules may be in the form of computer-executable instruction stored on memory, hardware, or a combination thereof

The generation module 410 generates the order ID of the order between the seller and the buyer.

The preservation module 420 preserves a corresponding relationship between the order ID and a buyer ID.

The identification unit 430 identifies the distribution center located in the district where the buyer resides according to the order ID and the area code provided by the logistics information system. The buyer ID and the order ID are obtained from the e-commerce platform system and provided to the logistics information system by the seller.

The obtaining module 440 obtains the user information of the buyer according to the buyer ID and the order ID sent by the logistics information system.

The transmission module 450 sends the user information of the buyer to the logistics information system.

The memory 404 may include computer-readable media in the form of volatile memory, such as random-access memory (RAM) and/or non-volatile memory, such as read only memory (ROM) or flash RAM. The memory 705 is one example of computer-readable media.

Computer-readable media includes volatile and non-volatile, removable and non-removable media implemented in any method or technology for storage of information such as computer readable instructions, data structures, program modules, or other data. Examples of computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include transitory media such as modulated data signals and carrier waves.

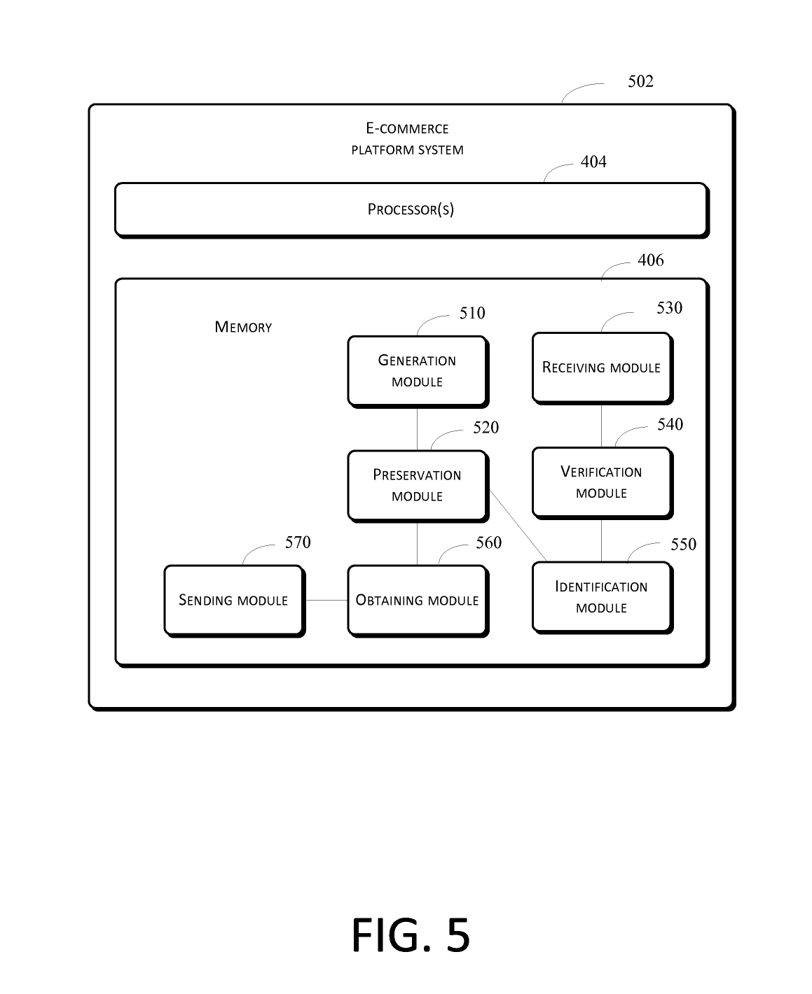

FIG. 5 illustrates a block diagram of another e-commerce platform system 502, which represents a second implementation of the system 310 in FIG. 3.

In the embodiment shown in FIG. 5, the e-commerce platform 502 may include, but is not limited to, one or more processors 404 and memory 406. The memory 406 may store therein one or more modules and/or program data. The program modules may include a generation module 510, a preservation module 520, a receiving module 530, a verification module 540, an identification module 550, an obtaining module 560, and a transmission module 570. The modules may be in the form of computer-executable instruction stored on memory, hardware, or a combination thereof

The generation module 510 generates the order ID of the order between the seller and the buyer.

The preservation module 520 preserves a corresponding relationship between the order ID and a buyer ID. The preservation module 520 may also preserve the user information of the buyer input during registration. The user information may include, singly or in combination, the buyer ID, name, telephone number, address, and zip code.

The receiving module 530 receives the request from the logistics information system to verify whether the buyer ID matches the order ID, after the preservation module 520 preserves the relationship between the order ID and a buyer ID.

The verification module 540 triggers functionality of the identification module 550 after verifying that the buyer ID matches the order ID.

The identification unit 550 identifies the distribution center located in the district where the buyer resides according to the order ID and the area code provided by the logistics information system. The buyer ID and the order ID are obtained from the e-commerce platform system and provided to the logistics information system by the seller.

The obtaining module 560 obtains the user information of the buyer according to the buyer ID and the order ID sent by the logistics information system.

The transmission module 570 sends the user information of the buyer to the logistics information system.

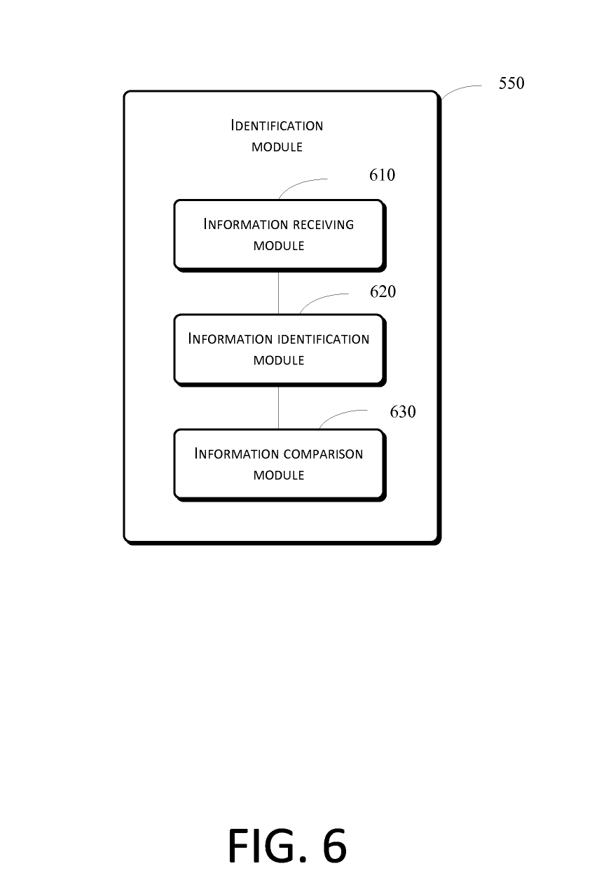

FIG. 6 shows a block diagram of an example identification module 550. As shown, the identification module 550 may include an information receiving module 610, an information identification module 620, and an information comparison module 630.

The information receiving module 610 receives the order ID and the area code of the current distribution center provided by the logistics information system. The information identification module 620 identifies the user information corresponding to the buyer according to the order ID. The information comparison module 630 determines that the current distribution center as the distribution center located in the district where the buyer resides when the area code matches the area code of the buyer recorded in the user information.

According to the above embodiment, the present disclosure can identify user information by docking the e-commerce platform and the logistics information systems without any encryption algorithm. The seller cannot obtain the user information of the buyer and accordingly the user information of the buyer is secured. The user information can be obtained according to the order ID and the buyer ID while identifying the user information through the e-commerce platform. The identification speed of identifying the user information in the system can be improved as fewer characters will be compared. As the risk of obtaining and leaking the user information of the buyer during the product transport process is reduced, and the user information of the buyer can be deleted once the delivery is completed, the illegal access to the user information from a third-party can be prevented and the privacy of the buyer can be protected. In addition, as the seller only provides limited information such as the order ID and the buyer ID, the error rate of information can be reduced and consequently the user's time can be saved.

Persons in this technical field can clearly understand that all or parts of the flows of the aforementioned embodiments in the present disclosure can be implemented by using the software with necessary general hardware. Based on the understanding, the technical solutions of the present disclosure in essence can be implemented in a form of software products. The computer software products can be stored in a computer accessible storage medium, such as ROM/RAM, disks, optical disks, etc., and certain instructions are used to make computer equipment (such as a personal computer, a server or network equipment, etc.) to operate the embodiments or certain methods described in some parts of the embodiments of the present disclosure.

The embodiments of the present disclosure are described in a progressive way and similar parts of the embodiments can be cross-referenced. What is emphasized in each embodiment refers to the parts different from other embodiments. For the embodiment of the system, as its basic principles are similar to the embodiment of the method, details are omitted for clarity and the relevant parts can be found in the embodiments of the method.

The embodiments are merely for illustrating the present disclosure and are not intended to limit the scope of the present disclosure. It should be understood for persons in this technical field that certain modifications and improvements can be made and should be considered under the protection of the present disclosure without departing from the principles of the present disclosure.

According to the above exemplary embodiments, the e-commerce platform system generates the order ID of the seller and the buyer and stores a relationship between the order ID and a buyer ID. The e-commerce platform system identifies the distribution center located in the district where the buyer resides according to the order ID and the area code provided by the logistics information system, and obtains user information of the buyer according to the buyer ID and the order ID sent by the logistics information system. The e-commerce system then sends the user information of the buyer to the logistics information system. In the example embodiment, the present disclosure identifies the user information based on communication between the e-commerce platform and the logistics information systems. In one example embodiment, the encryption algorithm is not used. The user information is identified through a connection between the e-commerce platform and the logistics information system. Thus the seller cannot obtain the user information of the buyer and the user information of the buyer cannot be leaked, thereby increasing security. When the user information is identified through the e-commerce platform, the user information can be obtained according to the order ID and the buyer ID. The identification speed is improved as few characters are compared in the identification process. In addition, as the seller provides limited information such as the order ID and the buyer ID, the error rate of information may be reduced and consequently the user's time can be saved.

From the exemplary embodiments described above, one of ordinary skill in the art can clearly understand that the disclosed method and system may be implemented using software with universal hardware platform. Based on this understanding, the technical scheme of the present disclosure may be implemented in the form of software products which are stored in a storage media such as ROM/RAM, hard drive and optical disk. The software includes computer-executable instructions for a computing device (e.g., personal computer, server or networked device) to execute the method described in the exemplary embodiments of the present disclosure.

The various exemplary embodiments are progressively described in the present disclosure. Same or similar portions of the exemplary embodiments can be mutually referenced. Each exemplary embodiment has a different focus than other exemplary embodiments. In particular, the exemplary system embodiment has been described in a relatively simple manner because of its fundamental correspondence with the exemplary method. Details thereof can be referred to related portions of the exemplary method. Descriptions of the above exemplary system are meant for illustrative purpose only. Units or modules described as separate components therein may or may not be physically separated. Components illustrated in terms of units may or may not be physical units, e.g., may be located in one place or may be distributed among multiple network units. Depending on the actual needs, the goal of the exemplary embodiments may be achieved by selecting parts or all of the modules. One of ordinary skill in the art can understand and implement the disclosed system without any innovative effect.

The disclosed method and system may be used in an environment or in a configuration of universal or specialized computer systems. Examples include a personal computer, a server computer, a handheld device or a portable device, a tablet device, a multi-processor system, a microprocessor-based system, a set-up box, a programmable customer electronic device, a network PC, a small-scale computer, a large-scale computer, and a distributed computing environment including any system or device above.

The present disclosure may be described within a general context of computer-executable instructions executed by a computer, such as a program module. Generally, a program module includes routines, programs, objects, modules, data structure, computer-executable instructions and etc., for executing specific tasks or implementing specific abstract data types. The disclosed method and server may also be implemented in a distributed computing environment. In the distributed computing environment, a task is executed by remote processing devices which are connected through a communication network. In distributed computing environment, the program module may be located in storage media (which include storage devices) of local and/or remote computers.

Above are exemplary embodiments of the present disclosure. However, the present disclosure is not limited hereto. It is appreciated that one of ordinary skill in the art can alter or modify the present disclosure in many different ways without departing from the spirit and the scope of this disclosure. These modifications and variations should therefore be considered to fall within the scope of the claims of the present disclosure and their equivalents.

What is claimed is:

1. A method for securing user information comprising:
generating, by an e-commerce platform system, an order identification (ID) of an order between a seller and a buyer and preserving, by the e-commerce platform system, a corresponding relationship between the order ID and a buyer ID of the buyer;
identifying, by the e-commerce platform system, a distribution center located in an area where the buyer resides according to the order ID and an area code provided by a logistics information system; and
sending, by the e-commerce platform system, user information of the buyer, which are obtained according to the buyer ID and the order ID provided by the logistics information system, to the logistics information system.

2. The method as recited in claim 1, wherein the buyer ID and the order ID are obtained by the seller from the e-commerce platform system and provided by the seller to the logistics information system.

3. The method as recited in claim 1, further comprising preserving, by the e-commerce platform system, the user information input by the buyer during registration, the user information including one or more of:
the buyer ID;
a buyer name;
a telephone number;
an address; and
a zip code.

4. The method as recited in claim 1, wherein after preserving the corresponding relationship between the order ID and the buyer ID, the method further comprising:
receiving, by the e-commerce platform system, a request from the logistics information system to verify whether the buyer ID matches the order ID; and
after determining that the buyer ID matches the order ID, identifying, by the e-commerce platform system, the distribution center located in the area where the buyer resides according to the order ID and the area code provided by the logistics information system.

5. The method as recited in claim 1, wherein the identifying the distribution center located in the district where the buyer resides according to the order ID and the area code provided by the logistics information system comprises:
receiving the order ID and the area code of a current distribution center provided by the logistics information system;
identifying the user information corresponding to the buyer according to the order ID; and
after determining that the area code matches an area of a district where the buyer resides, determining that the current distribution center is the distribution center located in the area where the buyer resides.

6. The method as recited in claim 1, further comprising sending, by the logistics information system, the user information of the buyer to a terminal equipment of the distribution center located in the area where the buyer resides.

7. The method as recited in claim 6, further comprising deleting, by the logistics information system, the user information recorded in the terminal equipment after the logistics information system determines a completion of a delivery of the order.

8. A system for securing user information comprising an e-commerce platform system, wherein:
the e-commerce platform system is configured to generate an order identification (ID) of an order between a seller and a buyer and preserve a corresponding relationship between the order ID and an ID of the buyer (buyer ID);
the e-commerce platform system is further configured to connect to a logistics information system that provides the order ID and an area code to the e-commerce platform system; and
the e-commerce platform system is further configured to identify a distribution center located in an area where the buyer resides according to the order ID and the area code provided by the logistics information system, and to send user information of the buyer to the logistics information system.

9. The system as recited in claim 8, wherein the buyer ID and the order ID are obtained by the seller from the e-commerce platform system and provided by the seller to the logistics information system.

10. The system as recited in claim 8, wherein the e-commerce platform system further preserves the user information inputted by the buyer during a registration, the user information including one or more of:
the buyer ID;
a buyer name;
a telephone number;
an address; and
a zip code.

11. The system as recited in claim 8, wherein the e-commerce platform is further configured to:
receives a request from the logistics information system to verify whether the buyer ID matches the order ID after preserving the corresponding relationship between the order ID and the buyer ID; and
after determining that the buyer ID matches the order ID, identifies the distribution center located in the area where the buyer resides according to the order ID and the area code provided by the logistics information system.

12. The system as recited in claim 8, wherein the e-commerce platform system further:
receives the order ID and the area code of a current distribution center provided by the logistics information system;
identifies the user information corresponding to the buyer according to the order ID; and
after determining that the area code matches an area of a district where the buyer resides, determining that the current distribution center is the distribution center located in the area where the buyer resides.

13. The system as recited in claim 8, wherein the logistic information system further sends the user information of the buyer to a terminal equipment of the distribution center located in the area where the buyer resides.

14. The system as recited in claim 13, wherein the logistics information system further deletes the user information recorded in the terminal equipment after the logistics information system determines a completion of a delivery of the order.

15. An e-commerce platform system comprising:
one or more processors; and
memory having stored therein modules that are executable on the one or more processors, the modules including:
a generation module that generates an order identification (ID) of an order between a seller and an ID of the buyer (buyer ID);
a preservation module that preserves a corresponding relationship between the order ID and the buyer ID;
an identification module that identifies a distribution center located in an area where the buyer resides according to the order ID and an area code provided by a logistics information system;
an obtaining module that obtains user information of the buyer according to the buyer ID and the order ID sent by the logistics information system; and
a transmission module that sends the user information of the buyer to the logistics information system.

16. The e-commerce platform system as recited in claim 15, wherein the buyer ID and the order ID are obtained by the seller from the e-commerce platform system and provided by the seller to the logistics information system.

17. The e-commerce platform system as recited in claim 15, wherein the preservation module further preserves the user information inputted by the buyer during a registration, the user information including one or more of:
the buyer ID;
a buyer name;
a telephone number;
an address; and
a zip code.

18. The e-commerce platform system as recited in claim 15, further comprising:
a receiving module that receives a request from the logistics information system to verify whether the buyer ID matches the order ID after the preservation module preserves the corresponding relationship between the order ID and the buyer ID; and
a verification module that triggers functionality of the identification module after determining that the buyer ID matches the order ID.

19. The e-commerce platform system as recited in claim 15, wherein the identification module further comprises:
an information receiving module that receives the order ID and an area code of a current distribution center provided by the logistics information system;
an information identification module that identifies the user information corresponding to the buyer according to the order ID; and
an information comparison module that determines that the current distribution center as the distribution center located in an area where the buyer resides when the area code matches the area code of the buyer recorded in the user information.

20. The e-commerce platform system as recited in claim 15, where in the user information of the buyer are identified through communication between the e-commerce platform system and the logistics information system, the user information not being encrypted at the e-commerce platform system.
